(19) United States
(12) Patent Application Publication
(10) Pub. No.: US 2023/0142068 A1
(43) Pub. Date: May 11, 2023

(54) MOTOR BRAKE DEVICE AND BABY CARRIAGE COMPRISING SAME

(71) Applicant: CHUZHOU BETTYMA BABY CARRIER CO., LTD., Chuzhou City, Anhui (CN)

(72) Inventors: Dajun Xu, Chuzhou City, Anhui (CN); Wujun Zhu, Chuzhou City, Anhui (CN); Yinyue Wang, Chuzhou City, Anhui (CN)

(73) Assignee: CHUZHOU BETTYMA BABY CARRIER CO., LTD., Chuzhou City, Anhui (CN)

(21) Appl. No.: 17/911,729

(22) PCT Filed: Nov. 13, 2020
(86) PCT No.: PCT/CN2020/128774

§ 371 Date: Sep. 15, 2022

(30) Foreign Application Priority Data
Aug. 24, 2020 (CN) 202010858641.6

(51) Int. Cl. H02K 7/102; H02K 7/116; B62B 9/08; F16D 55/22; F16D 65/18

(52) U.S. Cl. CPC H02K 7/102; H02K 7/116; B62B 9/085; F16D 55/22; F16D 65/18; F16D 2121/14

(57) ABSTRACT

A motor brake device, comprising a supporting assembly (1), a movable rotating disc (2), a pressing assembly (4), a lower cover (5), a sliding block (6), an elastic member, a brake assembly (7), and an upper cover (8). The supporting assembly (1) is fixed to a bottom housing (103) of a motor (10); a motor shaft head portion (102) extends out of a housing (104) of the motor (10), and a motor shaft tail portion (101) extends out of the bottom housing (103) of the motor (10) and penetrates through the supporting assembly (1); the movable rotating disc (2) is mounted on the motor shaft tail portion (101); the motor shaft tail portion (101) drives the movable rotating disc (2) to rotate synchronously; the pressing assembly (4) is movably connected to the lower cover (5); the lower cover (5) and the supporting assembly (1) are connected and fixed by means of a first connecting member; the sliding block (6) is connected to the elastic member, the sliding block (6) is connected to the brake assembly (7), and the sliding block (6) and the elastic member are mounted in the upper cover (8); the upper cover (8) and the lower cover (5) are connected and fixed by means of a second connecting member. During braking, the brake assembly (7) can enable the sliding block (6) to move synchronously, the sliding block (6) drives the pressing assembly (4) to move towards the movable rotating disc (2), and the pressing assembly (4) can be in contact with and press the movable rotating disc (2), so that the movable rotating disc (2) stops rotating, the elastic member enables the sliding block (6) to reset after the brake is released, and the pressing assembly (4) does not press the movable rotating disc (2) any more.

### TECHNICAL FIELD

The present invention relates to a motor brake device and baby carriage comprising same.

### BACKGROUND ART

At present, the motor brake technology relies on an electronic power-off brake. When this operates normally, power consumption is relatively high; for power-driven electric vehicles, electricity is wasted. When battery voltage is too low, the electronic brake only works intermittently, affecting normal use. The present motor uses a mechanical brake, which exhibits poor directivity of the left and right motor brakes.

### SUMMARY OF THE INVENTION

### Technical Problems

The present electronic brake for the motor is powered by a battery. When the battery voltage is too low, the electronic brake only works intermittently, affecting normal use. The present motor uses a mechanical brake, which exhibits poor directivity of the left and right motor brakes.

### Solutions to Problems

### Technical Solutions

The technical problem to be solved by the present invention is to provide a motor brake device that uses a mechanical brake with a simple and compact structure, providing stable brake performance and good directivity, and can also be used in conjunction with electronics, making it safer.

In order to solve the above technical problems, the present invention is implemented by means of the following technical solutions:

A motor brake device, comprising a supporting assembly, a movable rotating disc, a pressure device, a lower cover, a sliding block, an elastic component, a brake assembly, and an upper cover. The supporting assembly is fixed to the bottom housing of the motor; a motor shaft head portion extends out of the housing of the motor, and the motor shaft tail portion extends out of the bottom housing of the motor and penetrates through the supporting assembly; the movable rotating disc is directly or indirectly mounted on the motor shaft tail portion; the motor shaft tail portion drives the movable rotating disc to rotate synchronously; the pressure device is movably connected to the lower cover, the lower cover and the supporting assembly are connected and fixed by means of a first connector, the sliding block is connected to the elastic component, one end of the sliding block is connected to the brake assembly, and the sliding block and the elastic component are mounted on the upper cover; the upper cover and the lower cover are connected and fixed by means of a second connector. During braking, the brake assembly can enable the sliding block to move synchronously, the sliding block drives the pressure device to move towards the movable rotating disc, and the pressure device can be in contact with and press the movable rotating disc, so that the movable rotating disc stops rotating, the elastic component enables the sliding block to reset after the brake is released, and the pressure device does not press the movable rotating disc any more. With such a structure, the motor brake device is integrated with the motor, the movable rotating disc is directly or indirectly mounted on the motor shaft tail portion, the motor shaft tail portion drives the movable rotating disc to rotate synchronously, and during rotation, the movable rotating disc can be in contact with, press and separate the pressure device moving along the axial direction of the motor shaft tail portion, in order to brake and separate the motor. The sliding block drives the pressure device to move towards the movable rotating disc, the elastic component enables the sliding block to reset and separate the pressure device from the movable rotating disc. This kind of mechanical brake ensures a simple and compact structure, stable brake performance and good directivity, and can also be used in conjunction with electronics, making it safer to operate.

As an improvement of the present invention, the supporting assembly includes a fixed base and a fixed disc. A through-hole I for inserting the motor shaft tail portion is opened in the middle of the fixed base, and a through-hole II for inserting the motor shaft tail portion is opened in the middle of the fixed disc. The fixed disc screw fixes the fixed disc and the fixed base to the bottom housing of the motor.

As an improvement of the present invention, a matching motor shaft block is installed at the end of the motor shaft tail portion, a through-hole III matching the end of the motor shaft tail portion is opened in the middle of the motor shaft block, a square hole matching the motor shaft block is opened in the middle of the movable rotating disc, the motor shaft block is stuck in the square hole of the movable rotating disc, and the motor shaft block does not protrude from the plane of the movable rotating disc away from the motor, so as to enable the motor shaft tail portion to drive the motor shaft block to rotate synchronously, and the motor shaft block drives the movable rotating disc to rotate synchronously.

As an improvement of the present invention, the pressure device includes a pressure plate and a top pillar. The pressure plate is in contact with the bottom surface of the top pillar, and the top end of the top pillar extends out of the middle of the top surface of the lower cover. The top pillar includes a long columnar part and a disc part. The bottom of the columnar part is connected with the top of the disc part, the cross section of the columnar part is non-circular, the top surface of the disc part protrudes outward from the bottom surface of the columnar part, an inclined surface is arranged on the top of the columnar part, and the inclined surface slopes down from front to back.

As an improvement of the present invention, a flat cylindrical inner cavity is arranged below the lower surface of the lower cover. A through-hole IV is opened in the middle of the top surface of the lower cover, and the shape and size of the through-hole IV are matched with the columnar part. Multiple through-holes V are opened on the top surface of the lower cover, and the first connector is inserted into the through-hole V. An axial circular column I is arranged in the middle of the flat cylindrical inner cavity of the lower cover, and a circular hole-shaped groove is recessed into the circular column I. The disc part slides along the circular hole-shaped groove, and the through-hole IV is opened in the middle of the bottom wall of the circular hole-shaped groove. The lower cover abuts on the fixed disc.

As an improvement of the present invention, the sliding block comprises a sloping plate and a connecting part I connected to one end of the sloping plate. The sloping plate slopes down from front to back, matching the inclined surface on the top of the columnar part. The elastic component is a spring, and the connecting part I abuts on the spring. A clamping hole is opened in the connecting part I, a slot I is made on the contact surface between the connecting part I and the spring, and the slot I is connected with the clamping hole. The direction of movement of the sliding block is perpendicular to the motor shaft.

As an improvement of the present invention, the brake assembly includes a steel wire rope with a raised head and a brake wire jacket. The raised head of the steel wire rope is inserted into the clamping hole in the connecting part of the sliding block, and the steel wire rope is clamped into the slot I.

As an improvement of the present invention, the upper cover includes a first holder and second holder which are connected together. The first holder includes a first holding groove with the opening facing downward, and the sliding block and the spring are located in the first holding groove. When the brake is released, one end of the sliding block abuts on the spring, and the other end of the sliding block abuts on the rear side wall of the first holding groove, and the spring abuts on the front side wall of the first holding groove. The front side wall of the first holding groove features a slot II. The second holder is in the shape of a circular pipe, and includes a straight slot I corresponding to the slot II. The steel wire rope passes through the straight slot I and is clamped into the slot II. One end of the brake wire jacket is inserted into the second holder and abuts on the front side wall of the first holding groove. A connecting part II is arranged on both sides of the first holder, a through-hole VI is opened on the connecting part II, and the second connecting part of the upper cover and the lower cover is inserted into the through-hole VI.

As an improvement of the present invention, the motor brake device also comprises a spring sheath. The spring sheath comprises a flat plate-shaped spring sheath body; a clamping strip protruding downward is made on the rear end of the spring sheath body, a connecting plate protruding upward is made on the front end of the spring sheath body, and a through-hole VII is made on the connecting plate. A left guard plate is provided on the left side of the spring sheath body, and a right guard plate is provided on the right side of the spring sheath body. A long hole is opened at the edge of the top surface of the lower cover, and the clamping strip is inserted into the long hole of the lower cover. The second holder is inserted into the through-hole VII, and the first holder is located between the left guard plate and the right guard plate.

As an improvement of the present invention, the cross section of the columnar part is a rounded rectangle, and the inclined surface is an inclined plane.

As an improvement of the present invention, the first connector is composed of lower cover fixing screws. There are three lower cover fixing screws. Three threaded holes II for threaded connection with the lower cover fixing screws are opened uniformly at the edge of the fixed disc. The pressure plate is a circular flat plate, with three arc grooves formed inwardly in a uniform, concave shape on the outer circumference of the pressure plate. Three circular columns II are arranged uniformly at the edge of the flat cylindrical inner cavity, and the through-hole V is opened in the middle of the circular column II. The circular column II is inserted into the arc groove of the pressure plate and slides along the arc groove. The bottom surface of the circular column II is flush with the bottom surface of the lower cover. The movable rotating disc and the pressure plate are both located in the flat cylindrical inner cavity of the lower cover.

As an improvement of the present invention, the second connector is composed of upper cover fixing screws. There are two upper cover fixing screws. Two circular columns III are also symmetrically arranged at the edge of the flat cylindrical inner cavity. A threaded hole III for threaded connection with the upper cover fixing screws is opened in the middle of the circular column III. The bottom surface of the circular column II protrudes from the bottom surface of the circular column III.

As an improvement of the present invention, a left side wall and a right side wall are connected on either side of the sloping plate and the connecting part I, the other end of the sloping plate is connected with a rear side wall, while the rear side wall is connected with the left side wall and the right side wall respectively. The contact surface between the connecting part I and the spring is a plane, and the clamping hole is a through-hole.

As an improvement of the present invention, multi-layer annular steps are arranged in the upper part of the lower cover, the top surface of the lower cover is a plane, and the through-holes V are uniformly arranged at the edge of the top surface of the lower cover. A locating flange protruding downward is arranged at the edge of the connecting part II. The locating flange is connected with the rear side wall, and is clamped to the top of the lower cover.

Another technical problem to be solved by the present invention is to provide a baby carriage comprising a motor brake device. The baby carriage uses a mechanical brake with a simple and compact structure, stable brake performance and good directivity, and can also be used in conjunction with electronics, making it safer to operate.

In order to solve the above technical problems, the present invention is implemented by means of the following technical solution:

A baby carriage comprises the motor brake device described in any of the above, along with a wheel, a frame, a motor, a gearbox and a brake handle. The motor is fixed on the gearbox, the gearbox is fixed on the frame, the motor shaft head portion is connected with the gearbox, the wheel is connected with the gearbox, and the steel wire rope is connected and fixed to the brake handle.

### BENEFICIAL EFFECTS OF THE INVENTION

### Beneficial Effects

Compared with the prior art, the present invention has at least the following beneficial technical effects: the motor brake device of the present invention is integrated with the motor, the movable rotating disc is directly or indirectly mounted on the motor shaft tail portion, the motor shaft tail portion drives the movable rotating disc to rotate synchronously, and the movable rotating disc can be in contact with, press and separate from the pressure device as it moves axially along the motor shaft tail portion to realize braking and separation of the motor. The sliding block drives the pressure device to move to the movable rotating disc for pressing, and the elastic component resets the sliding block to separate the pressure device from the movable rotating disc. This type of mechanical brake ensures a simple and compact structure, stable brake performance and good directivity, and can also be used in conjunction with electronics together, making it safer to operate.

In order to ensure the purposes described above, as well as to make the characteristics and advantages of the present invention more obvious and easy to understand, the preferred embodiments are given in the following text, and will be described in detail in combination with the attached drawings.

### BRIEF DESCRIPTION OF THE ATTACHED DRAWINGS

### Description of Attached Drawings

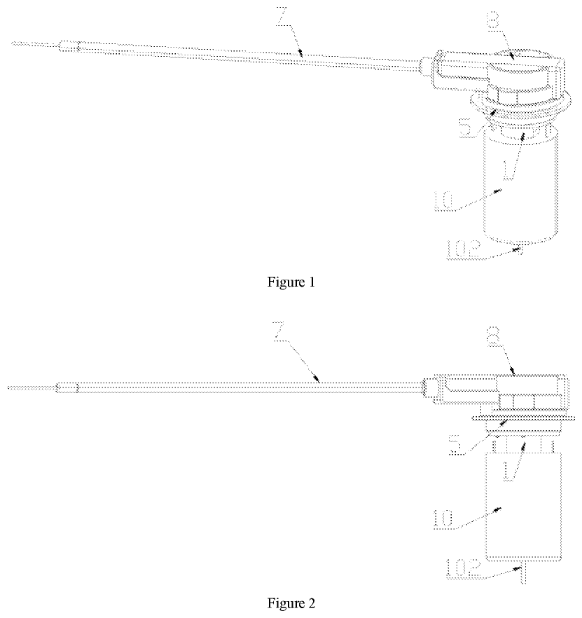

FIG. 1 is a structural diagram of a specific angle of the motor brake device of the present invention.

FIG. 2 is a front view of the motor brake device in FIG. 1.

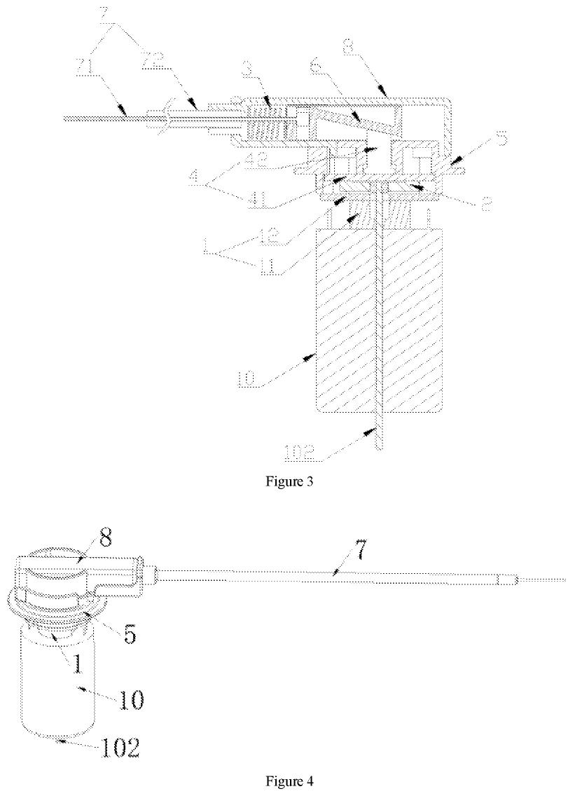

FIG. 3 is a sectional view of the motor brake device in FIG. 1.

FIG. 4 is a structural diagram of another angle of the motor brake device in FIG. 1.

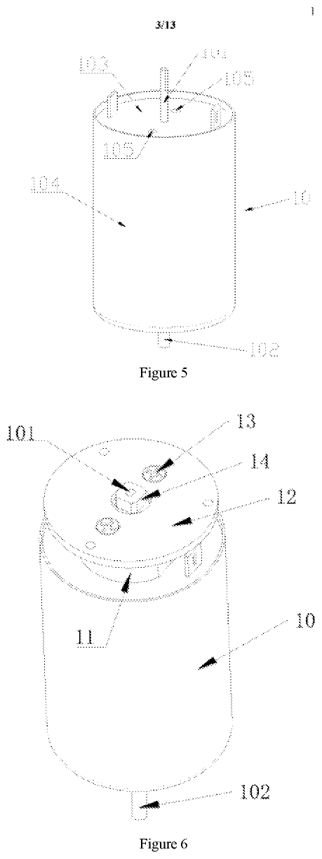

FIG. 5 is a structural diagram of the motor in FIG. 1.

FIG. 6 is a structural diagram of the supporting assembly in FIG. 1.

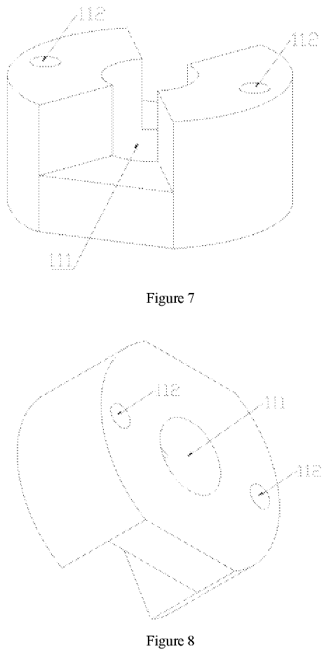

FIG. 7 is a structural diagram of a specific angle of the fixing base in FIG. 6.

FIG. 8 is a structural diagram of another angle of the fixing base in FIG. 7.

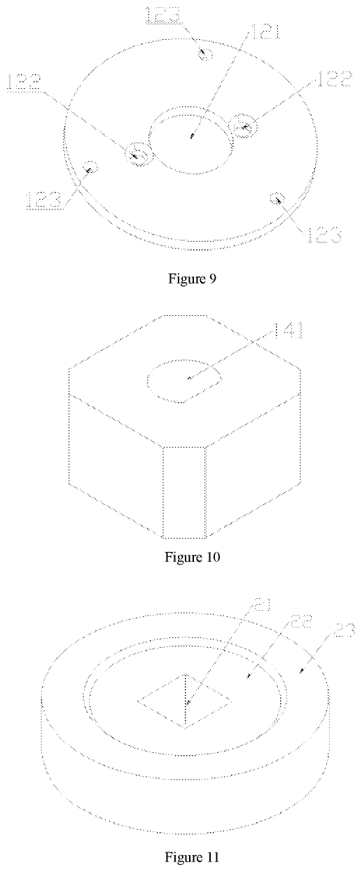

FIG. 9 is a structural diagram of the fixed disc in FIG. 6.

FIG. 10 is a structural diagram of the motor shaft block in FIG. 6.

FIG. 11 is a structural diagram of the movable rotating disc in FIG. 1.

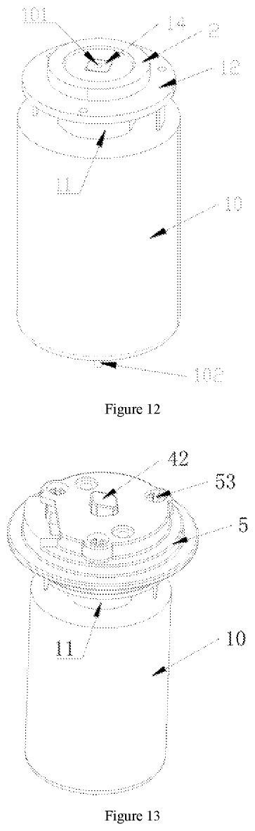

FIG. 12 is a structural diagram of the movable rotating disc mounted on the motor in FIG. 1.

FIG. 13 is a structural diagram of the pressure device in FIG. 1 mounted on the lower cover.

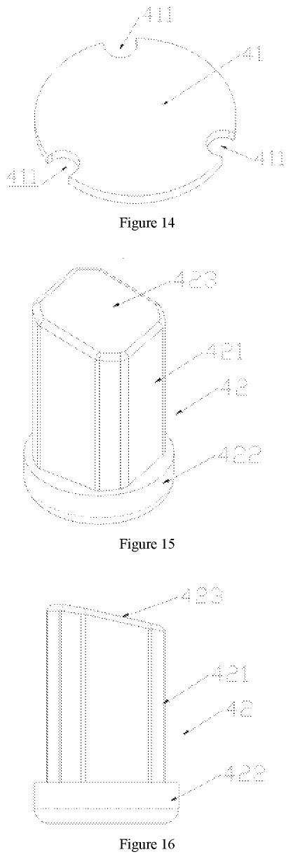

FIG. 14 is a structural diagram of the pressure plate in FIG. 13.

FIG. 15 is a structural diagram of the top pillar in FIG. 13.

FIG. 16 is a front view of the top pillar in FIG. 15.

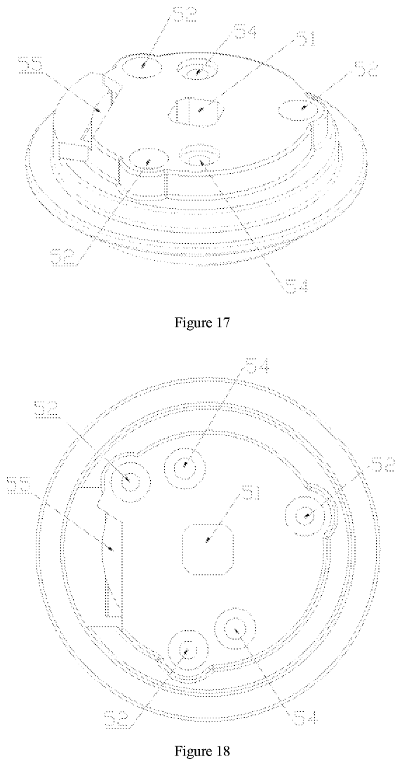

FIG. 17 is a structural diagram of the lower cover in FIG. 13.

FIG. 18 is a plan view of the lower cover in FIG. 17.

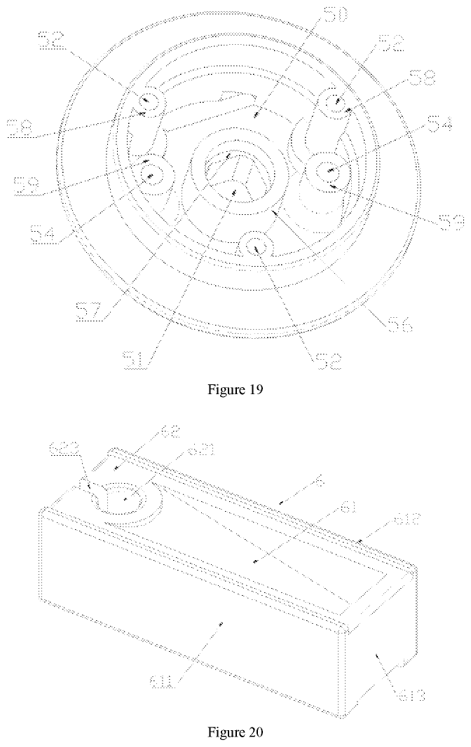

FIG. 19 is a structural diagram of the back of the lower cover in FIG. 17.

FIG. 20 is a structural diagram of a specific angle of the sliding block in FIG. 3.

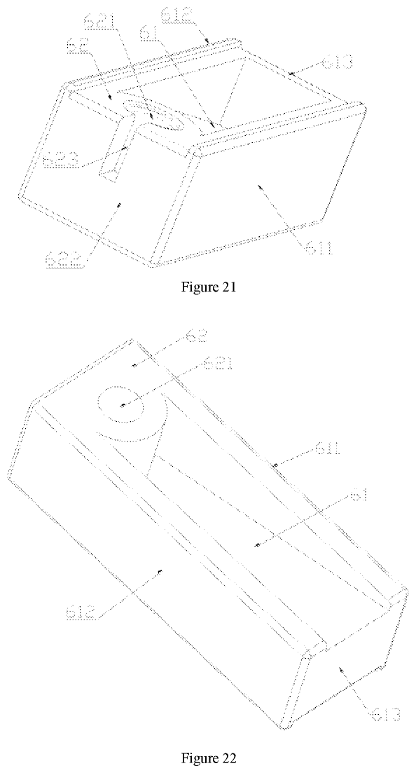

FIG. 21 is a structural diagram of another angle of the sliding block in FIG. 20.

FIG. 22 is a structural diagram of the back of the sliding block in FIG. 20.

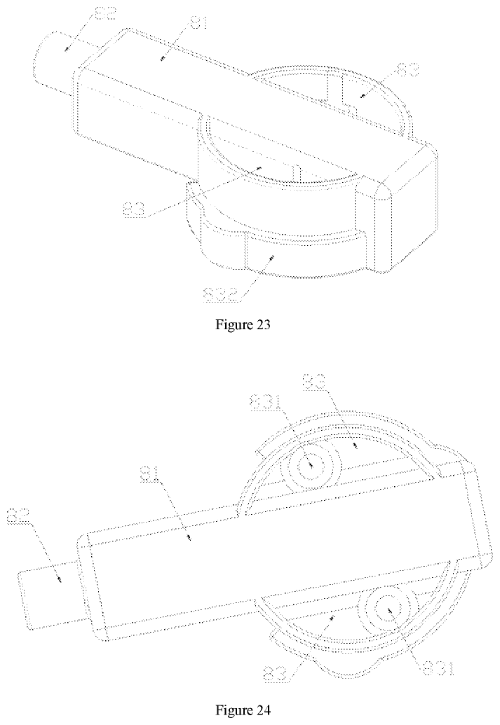

FIG. 23 is a structural diagram of the upper cover in FIG. 1.

FIG. 24 is a plan view of the upper cover in FIG. 23.

FIG. 25 is a structural diagram of the back of the upper cover in FIG. 23.

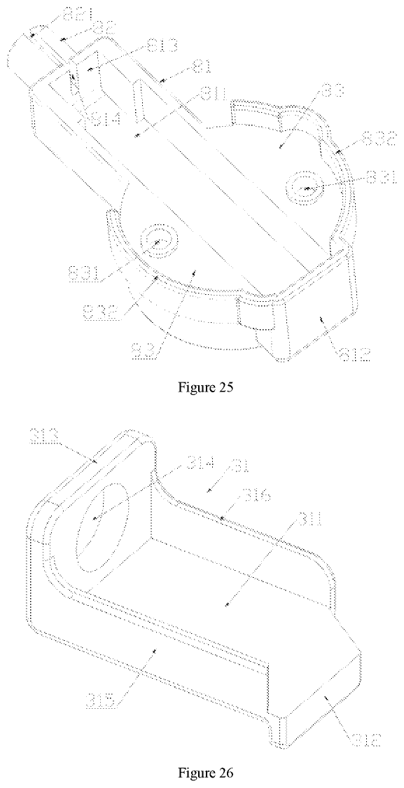

FIG. 26 is a structural diagram of the protective spring cover in FIG. 1.

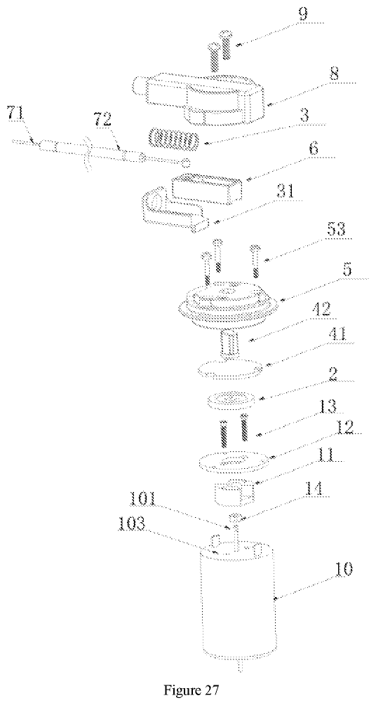

FIG. 27 is an exploded view of the motor brake device in FIG. 1

### EMBODIMENTS OF THE INVENTION

### Implementation Method of the Present Invention

In order to further elaborate the technical means adopted by the present invention, and the means by which the intended purpose of the invention is achieved, the specific implementation method, structure, characteristics and effects of the present invention are described below in combination with the attached drawings and preferred embodiments. See the following for details.

In the description of the present application, it should be understood that the orientation or positional relationship indicated by the terms “up”, “down”, “inside”, “outside”, “left”, “right”, “front” and “back” are based on the orientation or positional relationship shown in the attached drawings, and are only for the convenience of describing the present application and simplifying the description, rather than indicating or implying that the device or element must be provided with a specific orientation, configured or operated in a specific orientation, therefore it cannot be interpreted as a restriction on the present application. In actual use, the motor and the motor brake device are arranged horizontally. In order to facilitate the description of the motor brake device, the motor and the motor brake device are arranged vertically in the manual

In order to more clearly describe the positional relationship of each part, the “up” and “down” in this application can be taken as the up and down shown in FIG. 3 and FIG. 16 as examples. The “front”, “back”, “left” and “right” in this application follow the front, back, left and right shown in FIG. 3, FIG. 16, FIG. 20, FIG. 23 and FIG. 26 as examples, and the forward direction of the baby carriage is taken as the front.

In addition, the terms “first” and “second” are only used for descriptive purposes and cannot be understood as indicating or implying relative importance or implicitly indicating the number of indicated technical features. The features defined as “first” and “second” may explicitly or implicitly include one or more of the features. In the description of this application, “multiple” means two or more, unless otherwise specifically defined.

In this application, unless otherwise specified and defined, the terms “mount”, “connect”, “connection” and “fix” should be understood in a broad sense. For example, there can be a fixed connection, a detachable connection, or an integrated connection; there can also be a mechanical connection or an electrical connection; there can be a direct connection, an indirect connection through an intermediate medium, or an internal connection between two elements. For professional technical personnel working in this field, the specific meanings of the above terms in the present application can be understood according to specific circumstances.

### Embodiment 1

As shown in FIG. 1 to FIG. 27, a motor brake device, comprising a supporting assembly 1, a movable rotating disc 2, a pressure device 4, a lower cover 5, a sliding block 6, an elastic component, a brake assembly 7, and an upper cover 8. The supporting assembly 1 is fixed to a bottom housing 103 of a motor 10; a motor shaft head portion 102 extends out of a housing 104 of the motor 10, and a motor shaft tail portion 101 extends out of the bottom housing 103 of the motor 10 and penetrates through the supporting assembly 1; the movable rotating disc 2 is mounted on the motor shaft tail portion 101; the motor shaft tail portion 101 drives the movable rotating disc 2 to rotate synchronously; the pressure device 4 is movably connected to the lower cover 5, the lower cover 5 and the supporting assembly 1 are connected and fixed by means of a first connector, the sliding block 6 is connected to the elastic component, one end of sliding block 6 is connected to the brake assembly 7, and the sliding block 6 and the elastic component are mounted on the upper cover 8; the upper cover 8 and the lower cover 5 are connected and fixed by means of a second connector. During braking, the brake assembly 7 can enable the sliding block 6 to move synchronously, the sliding block 6 drives the pressure device 4 to move towards the movable rotating disc 2, and the pressure device 4 can be in contact with and press the movable rotating disc 2, so as to make the movable rotating disc 2 stop rotating and make the motor shaft tail portion 101 stop rotating; the elastic component enables the sliding block 6 to reset after the brake is released, the sliding block 6 does not press the pressure device 4, the pressure device 4 can leave the movable rotating disc 2, and the pressure device 4 does not press the movable rotating disc 2 any more. In the embodiment, the elastic component is the spring 3, and one end of the sliding block 6 abuts on the spring 3. Of course, the elastic component may also be located at the other end of the sliding block 6, in which case the other end of the sliding block 6 is connected to the elastic component.

As shown in FIG. 5, the motor shaft head portion 102 of the motor 10 extends out of a housing 104 of the motor 10, and the motor shaft tail portion 101 extends out of the bottom housing 103 of the motor 10. An arc block is cut off from one end of the motor shaft tail portion 101 on the outer circumference, and the cross section is a plane. Two symmetrical threaded holes I 105 are opened on the bottom housing 103.

As shown in FIG. 6 to FIG. 10, the supporting assembly 1 includes a fixed base 11 and a fixed disc 12. A fixed disc screw 13 fixes the fixed disc 12 and the fixed base 11 to the bottom housing 103 of the motor 10. The fixed disc screw 13 can be screwed into the threaded hole I 105 on the bottom housing 103.

As shown in FIG. 7 to FIG. 8, a through-hole I 111 for inserting the motor shaft tail portion 101 is opened in the middle of the fixed base 11, two symmetrical screw holes I 112 are opened on the outer side of the fixed base 11, and the fixed disc screw 13 can be inserted into the screw hole I 112.

As shown in FIG. 9, a through-hole II 121 for inserting the motor shaft tail portion 101 is opened in the middle of the fixed disc 12, a relatively symmetrical screw hole II 122 is opened on both sides of the through-hole II 121, the fixed disc screw 13 can be inserted into the screw hole II 122, and the screw hole II 122 corresponds to the screw hole I 112. Three threaded holes II 123 are uniformly opened at the edge of the fixed disc 12. In this embodiment, the screw hole II 122 is a countersunk screw hole, and the fixed disc screw 13 is a flat head screw.

As shown in FIG. 6 and FIG. 10, a matching motor shaft block 14 is mounted at the end of the motor shaft tail portion 101, and a through-hole III 141 matching the end of the motor shaft tail portion 101 is opened in the middle of the motor shaft block 14.

As shown in FIG. 11 and FIG. 12, the movable rotating disc 2 is in the shape of a disc; a square hole 21 matching the motor shaft block 14 is opened in the middle of the movable rotating disc 2, the motor shaft block 14 can be stuck in the square hole 21 of the movable rotating disc 2, and the motor shaft block 14 does not protrude from the plane of the movable rotating disc 2 away from the motor 10, so that the motor shaft tail portion 101 drives the motor shaft block 14 to rotate synchronously, and the motor shaft block 14 drives the movable rotating disc 2 to rotate synchronously. A circular groove 22 is recessed downward on the inner side of the top surface of the movable rotating disc 2, the square hole 21 is located in the middle of the circular groove 22, and an annular plane 23 is formed on the outer side of the top surface of the movable rotating disc 2.

As shown in FIG. 13 to FIG. 16, the pressure device 4 includes a pressure plate 41 and a top pillar 42. The pressure plate 41 touches the bottom surface of the top pillar 42, the top end of the top pillar 42 extends out of the middle of the top surface of the lower cover 5, and the top pillar 42 can move axially in the lower cover 5.

As shown in FIG. 14, the pressure plate 41 is a circular flat plate, and three arc grooves 411 are uniformly recessed inward on the outer circumference of the pressure plate 41 for limiting the pressure plate 41 by means of the lower cover 5.

As shown in FIG. 15 to FIG. 16, the top pillar 42 includes a long columnar part 421 and a disc part 422. The bottom of the columnar part 421 is connected with the top of the disc part 422, the cross section of the columnar part 421 is non-circular, and the diameter of the disc part 422 is greater than the maximum distance of the cross section of the columnar part 421. The top surface of the disc part 422 protrudes outward from the bottom surface of the columnar part 421. An inclined surface 423 is arranged on the top of the columnar part 421, and the inclined surface 423 slopes down from front to back. In this embodiment, the cross section of the columnar part 421 is a rounded rectangle, and the inclined surface 423 is an inclined plane.

As shown in FIG. 13, FIG. 17 to FIG. 19, in this embodiment, a flat cylindrical inner cavity 50 is arranged below the lower surface of the lower cover 5. A through-hole IV 51 is opened in the middle of the top surface of the lower cover 5, and the shape and size of the through-hole IV 51 are matched with the columnar part 421. A multi-layer ring step is arranged in the upper part of the lower cover 5, and three through-holes V 52 are opened at the edge of the top surface of the lower cover 5. In this embodiment, the first connector for connecting the lower cover 5 and the supporting assembly 1 is the lower cover fixing screw 53, and the lower cover fixing screw 53 can be inserted into the through-hole V 52. The lower cover fixing screw 53 fixes the lower cover 5 to the fixed disc 12, and the lower cover fixing screw 53 is tightened in the threaded hole II 123. A threaded hole III 54 is symmetrically opened on both sides of the through-holes IV 51 on the top surface of the lower cover 5, and a long hole 55 is opened at the edge of the top surface of the lower cover 5. An axial circular column I 56 is arranged in the middle of the flat cylindrical inner cavity 50 of the lower cover 5. A circular hole-shaped groove 57 is recessed in the circular column I 56. The disc part 422 slides along the circular hole-shaped groove 57, the through-hole IV 51 is opened in the middle of the bottom wall of the circular hole-shaped groove 57. The lower cover 5 abuts on the fixed disc 12, and the movable rotating disc 2 and the pressure plate 41 are located in the inner cavity of the lower cover 5. Three circular columns II 58 are arranged uniformly at the edge of the flat cylindrical inner cavity 50, and the through-hole V 52 is opened in the middle of the circular column II 58. Two circular columns III 59 are also symmetrically arranged at the edge of the flat cylindrical inner cavity 50. The threaded hole III 54 is opened in the middle of the circular column III 59. The top surface of the lower cover 5 is a plane, and the bottom surface of the circular column II 58 is flush with the bottom surface of the lower cover 5, and protrudes from the bottom surface of the circular column III 59. The circular column II 58 is inserted into the arc groove 411 of the pressure plate 41 and slides along the arc groove 411. The circular column II 58 limits the rotation of the pressure plate 41 to prevent the pressure plate 41 from rotating. The circular column III 59 limits the upward movement distance of the pressure plate 41 (the direction of the upper cover 8).

As shown in FIG. 3, and in FIG. 20 to FIG. 22, in this embodiment, the sliding block 6 comprises a sloping plate 61 and a connecting part I 62 connected to one end of the sloping plate 61. The upper surface and the lower surface of the sloping plate 61 are inclined surfaces that gradually slope upwards. The sloping plate 61 slopes down from front to back, and is matched with the inclined surface 423 on the top of the columnar part 421. The elastic component is the spring 3, which is located in front of the sliding block 6. The spring 3 is a pressure spring, and the connecting part I 62 abuts on the spring 3. A left side wall 611 and a right side wall 612 are connected on both sides of the sloping plate 61 and the connecting part I 62, the other end of the sloping plate 61 is connected with a rear side wall 613, and the rear side wall 613 is connected with the left side wall 611 and the right side wall 612 respectively. A clamping hole 621 is opened on the connecting part I 62. The contact surface 622 between the connecting part I 62 and the spring 3 is a plane, a slot I 623 is made on the contact surface 622 between the connecting part I 62 and the spring 3, and the slot I 623 is connected with the clamping hole 621. The direction of movement of the sliding block 6 is perpendicular to the motor shaft. In this embodiment, the clamping hole 621 is a through-hole. Of course, the clamping hole 621 may also be a blind hole. The spring 3 may also be located behind the sliding block 6; at this time, the spring 3 is a tension spring, and the other end of the sloping plate 61 is connected to the spring 3.

As shown in FIG. 1, FIG. 2, FIG. 3, FIG. 4 and FIG. 27, the brake assembly 7 includes a steel wire rope 71 with a raised head and a brake wire jacket 72. The raised head of the steel wire rope 71 is inserted into the through-hole VI 621 of the connecting part I 62 of the sliding block 6, and the steel wire rope 71 is clamped into the slot I 623.

As shown in FIG. 23 to FIG. 25, the upper cover 8 includes a connected first holder 81 and a second holder 82. The first holder 81 includes a first holding groove 811 with the opening pointing downward, and the sliding block 6 and the spring 3 are located in the first holding groove 811. When the brake is released, one end of the sliding block 6 abuts on the spring 3, the other end of the sliding block 6 abuts on the rear side wall 812 of the first holding groove 811, and the spring 3 abuts on the front side wall 813 of the first holding groove 811. The front side wall 813 of the first holding groove 811 includes a slot II 814. The second holder 82 is in the shape of a circular pipe, and includes a straight slot I 821 corresponding to the slot II 814. The steel wire rope 71 passes through the straight slot I 821 and is clamped into the slot II 814. One end of the brake wire jacket 72 is inserted into the second holder 82 and abuts on the front side wall 813 of the first holding groove 811. A connecting part II 83 is arranged on both sides of the first holder 81, a through-hole VI 831 is opened on the connecting part II 83, and the second connector of the upper cover 8 and the lower cover 5 can be inserted into the through-hole VI 831. In this embodiment, the second connector of the upper cover 8 and the lower cover 5 is an upper cover fixing screw 9, and the upper cover fixing screw 9 is tightened in the threaded hole III 54 of the lower cover 5. A locating flange 832 protruding downward is arranged at the edge of the connecting part II 83. The locating flange 832 is connected with the rear side wall 812, and is clamped with the top of the lower cover 5.

As shown in FIG. 1, FIG. 2, FIG. 3, FIG. 4 and FIG. 26, the motor brake device also comprises a spring sheath 31. The spring sheath 31 comprises a flat plate-shaped spring sheath body 311. A clamping strip 312 protruding downward is made on the rear end of the spring sheath body 311, and the clamping strip 312 is inserted into the long hole 55 of the lower cover 5. A connecting plate 313 protruding upward is made on the front end of the spring sheath body 311, and the through-hole VII 314 is made on the connecting plate 313. The second holder 82 is inserted into the through-hole VII 314. A left guard plate 315 is provided on the left side of the spring sheath body 311, and a right guard plate 316 is provided on the right side of the spring sheath body 311, and the first holder 81 is located between the left guard plate 315 and the right guard plate 316.

The installation process of the motor brake device is as follows:

1. Install the supporting assembly 1: Place the fixed base 11 and the fixed disc 12 on the motor shaft tail portion 101 of the motor 10, and fix the fixed disc 12 and the fixed base 11 on the bottom housing 103 of the motor 10 using the fixed disc screws 13. Place the motor shaft block 14 on the motor shaft tail portion 101 of the motor 10. An interference fit shall be adopted between the motor shaft block 14 and the motor shaft tail portion 101, and the motor shaft block 14 is driven by the motor shaft tail portion 101 to rotate synchronously;

2. Install the movable rotating disc 2: Clamp the movable rotating disc 2 onto the motor shaft block 14. Through the square hole in the middle, the motor shaft block 14 drives the movable rotating disc 2 to rotate synchronously;

3. Install the pressure device 4: Assemble the pressure plate 41 and the top pillar 42 on the lower cover 5, and fix the lower cover 5 to the fixed disc 12 with the lower cover fixing screws 53;

4. Place the spring sheath 31 and the spring 3 on the steel wire rope 71 and the brake wire jacket 72 in turn, clip the steel wire rope 71 into the slot of the sliding block 6, and then install the upper cover 8. Fix the upper cover 8 to the lower cover 5 using the upper cover fixing screw 9.

The braking principle of the motor brake device is described below:

The motor brake device is integrated with the motor, and moves up and down within a small gap through the movable rotating disc 2. The movable rotating disc 2 is in contact with and separates from the pressure plate 41 moving along the axial direction of the motor shaft tail portion 101 to realize braking and separation of the motor. The movement of the pressure plate 41 along the axial direction of the motor shaft tail portion 101 is accurately achieved by the top pillar 42 pushing the pressure plate 41 to contact and separate from the movable rotating disc 2. When the steel wire rope 71 is pulled, it drives the sliding block 6 to move in turn. The contact surface between the sliding block 6 and the top pillar 42 is an inclined surface that slopes gradually upwards. The contact surface is gradually raised by the movement of the sliding block 6. The sliding block 6 pushes the top pillar 42 to move toward the motor shaft tail portion 101. The top pillar 42 pushes the pressure plate 41 to contact and press the movable rotating disc 2, and to make the movable rotating disc 2 stop rotating and realize the braking of the motor. After the steel wire rope 71 is loosened, the force of the spring 3 drives the sliding block 6 to reset, the top pillar 42 retracts, and the pressure plate 41 and the movable rotating disc 2 are separated.

### Embodiment 2

A baby carriage comprises the motor brake device in the embodiment 1, as well as a wheel, a frame, a motor 10, a gearbox and a brake handle. The motor 10 is fixed on the gearbox, the gearbox is fixed on the frame, the motor shaft head portion 102 is connected with the gearbox, the wheel is connected with the gearbox, and the steel wire rope 71 is connected and fixed with the brake handle.

The above are only the preferred embodiments of the present invention, and are not limitations for the present invention in any form. Although the present invention has been disclosed as above in the preferred embodiments, these are not intended to limit the present invention. Any person skilled in the art, without departing from the scope of the technical solution of the present invention, can make some changes or embellishments to an equivalent embodiment by using the above disclosed technical content. However, any simple modification, equivalent change or embellishment made to the above embodiments according to the technical essence of the present invention that do not depart from the content of the technical solution, are still within the scope of the technical solution of the present invention.

### INDUSTRIAL APPLICABILITY

A motor brake device and baby carriage comprising same, as described in the present invention, have good industrial practicability. A mechanical brake is adopted, featuring a simple and compact structure, stable brake performance and good directivity, which can also be used in combination with electronics, making it safer to operate.

1. A motor brake device, characterized in that, it comprises a supporting assembly (1), a movable rotating disc (2), a pressure device (4), a lower cover (5), a sliding block (6), an elastic component, a brake assembly (7), and an upper cover (8). The supporting assembly (1) is fixed to a bottom housing (103) of a motor (10); a motor shaft head portion (102) extends out of a housing (104) of the motor (10), and a motor shaft tail portion (101) extends out of the bottom housing (103) of the motor (10) and penetrates through the supporting assembly (1); the movable rotating disc (2) is directly or indirectly mounted on the motor shaft tail portion (101); the motor shaft tail portion (101) drives the movable rotating disc (2) to rotate synchronously; the pressure device (4) is movably connected to a lower cover (5), the lower cover (5) and the supporting assembly (1) are connected and fixed by means of a first connector, the sliding block (6) is connected to the elastic component, one end of the sliding block (6) is connected to the brake assembly (7), and the sliding block (6) and the elastic component are mounted on an upper cover (8); the upper cover (8) and the lower cover (5) are connected and fixed by means of a second connector. During braking, the brake assembly (7) can enable the sliding block (6) to move synchronously, the sliding block (6) drives the pressure device (4) to move towards the movable rotating disc (2), and the pressure device (4) can be in contact with and press the movable rotating disc (2), so that the movable rotating disc (2) stops rotating, the elastic component enables the sliding block (6) to reset after the brake is released, and the pressure device (4) does not press the movable rotating disc (2) any more.

2. The motor brake device according to claim 1, characterized in that, the supporting assembly (1) includes a fixed base (11) and a fixed disc (12). A through-hole I (111) for inserting the motor shaft tail portion (101) is opened in the middle of the fixed base (11), and a through-hole II (121) for inserting the motor shaft tail portion (101) is opened in the middle of the fixed disc (12). The fixed disc screw (13) fixes the fixed disc (12) and the fixed base (11) to the bottom housing (103) of the motor (10).

3. The motor brake device according to claim 2, characterized in that, a matching motor shaft block (14) is installed at the end of the motor shaft tail portion (101), a through-hole III (141) matching the end of the motor shaft tail portion (101) is opened in the middle of the motor shaft block (14), a square hole (21) matching the motor shaft block (14) is opened in the middle of the movable rotating disc (2), the motor shaft block (14) is stuck in the square hole (21) of the movable rotating disc (2), and the motor shaft block (14) does not protrude from the plane of the movable rotating disc (2) away from the motor (10), so as to enable the motor shaft tail portion (101) to drive the motor shaft block (14) to rotate synchronously, and the motor shaft block (14) drives the movable rotating disc (2) to rotate synchronously.

4. The motor brake device according to claim 3, characterized in that, the pressure device (4) includes a pressure plate (41) and a top pillar (42). The pressure plate (41) is in contact with the bottom surface of the top pillar (42), and the top end of the top pillar (42) extends out of the middle of the top surface of the lower cover (5). The top pillar (42) includes a long columnar part (421) and a disc part (422). The bottom of the columnar part (421) is connected with the top of the disc part (422), the cross section of the columnar part (421) is non-circular, the top surface of the disc part (422) protrudes outward from the bottom surface of the columnar part (421), an inclined surface (423) is arranged on the top of the columnar part (421), and the inclined surface (423) slopes down from front to back.

5. The motor brake device according to claim 4, characterized in that, a flat cylindrical inner cavity (50) is arranged below the lower surface of the lower cover (5). A through-hole IV (51) is opened in the middle of the top surface of the lower cover (5), and the shape and size of the through-hole IV (51) are matched with the columnar part (421). Multiple through-holes V (52) are opened on the top surface of the lower cover (5), and the first connector is inserted into the through-hole V (52). An axial circular column I (56) is arranged in the middle of the flat cylindrical inner cavity (50) of the lower cover (5), and a circular hole-shaped groove (57) is recessed in the circular column I (56). A sliding fit is adopted between the disc part (422) and the circular hole-shaped groove (57), and the through-hole IV (51) is opened in the middle of the bottom wall of the circular hole-shaped groove (57). The lower cover (5) abuts on the fixed disc (12).

6. The motor brake device according to claim 5, characterized in that, the sliding block (6) comprises a sloping plate (61) and a connecting part I (62) connected to one end of the sloping plate (61). The sloping plate (61) slopes down from front to back, and is matched with the inclined surface (423) on the top of the columnar part (421). The elastic component is a spring (3), and the connecting part I (62) abuts on the spring (3). A clamping hole (621) is opened in the connecting part I (62), a slot I (623) is made on the contact surface (622) between the connecting part I (62) and the spring (3), and the slot I (623) is connected with the clamping hole (621). The direction of movement of the sliding block (6) is perpendicular to the motor shaft.

7. The motor brake device according to claim 6, characterized in that, the brake assembly (7) includes a steel wire rope (71) with a raised head and a brake wire jacket (72). The raised head of the steel wire rope (71) is inserted into the clamping hole (621) in the connecting part I (62) of the sliding block (6), and the steel wire rope (71) is clamped into the slot I (623).

8. The motor brake device according to claim 7, characterized in that, the upper cover (8) includes a connected first holder (81) and second holder (82). The first holder (81) includes a first holding groove (811) with the opening facing downward, and the sliding block (6) and the spring (3) are located in the first holding groove (811). When the brake is released, one end of the sliding block (6) abuts on the spring (3), and the other end of the sliding block (6) abuts on the rear side wall (812) of the first holding groove (811). The spring (3) abuts on the front side wall (813) of the first holding groove (811). The front side wall (813) of the first holding groove (811) includes a slot II (814). The second holder (82) is in the shape of a circular pipe, while the second holder (82) includes a straight slot I (821) corresponding to the slot II (814). The steel wire rope (71) passes through the straight slot I (821) and is clamped into the slot II (814). One end of the brake wire jacket (72) is inserted into the second holder (82) and abuts on the front side wall (813) of the first holding groove (811). A connecting part II (83) is arranged on both sides of the first holder (81), a through-hole VI (831) is opened on the connecting part II (83), and the second connecting part of the upper cover (8) and the lower cover (5) is inserted into the through-hole VI (831).

9. The motor brake device according to claim 8, characterized in that, the motor brake device also comprises a spring sheath (31). The spring sheath (31) comprises a flat plate-shaped spring sheath body (311); a clamping strip (312) protruding downward is made on the rear end of the spring sheath body (311), and a connecting plate (313) protruding upward is made on the front end of the spring sheath body (311). A through-hole VII (314) is made on the connecting plate (313), a left guard plate (315) is provided on the left side of the spring sheath body (311), and a right guard plate (316) is provided on the right side of the spring sheath body (311). A long hole (55) is opened at the edge of the top surface of the lower cover (5), and the clamping strip (312) is inserted into the long hole (55) of the lower cover (5). The second holder (82) is inserted into the through-hole VII (314), and the first holder (81) is located between the left guard plate (315) and the right guard plate (316).

10. The motor brake device according to claim 4, characterized in that, the cross section of the columnar part (421) is a rounded rectangle, and the inclined surface (423) is an inclined plane.

11. The motor brake device according to claim 5, characterized in that, the first connector is composed of several lower cover fixing screws (53). There are three lower cover fixing screws (53). Three threaded holes II (123) for threaded connection with the lower cover fixing screws (53) are opened uniformly at the edge of the fixed disc (12). The pressure plate (41) is a circular flat plate, featuring three arc grooves (411) formed inwardly in a uniform, concave shape on the outer circumference of the pressure plate (41). Three circular columns II (58) are arranged uniformly at the edge of the flat cylindrical inner cavity (50), and the through-hole V (52) is opened in the middle of the circular column II (58). The circular column II (58) is inserted into the arc groove (411) of the pressure plate (41) and slides along the arc groove (411). The bottom surface of the circular column II (58) is flush with the bottom surface of the lower cover (5). The movable rotating disc (2) and the pressure plate (41) are both located in the flat cylindrical inner cavity (50) of the lower cover (5).

12. The motor brake device according to claim 5, characterized in that, the second connector is composed of upper cover fixing screws (9). There are two upper cover fixing screws (9). Two circular columns III (59) are also symmetrically arranged at the edge of the flat cylindrical inner cavity (50). A threaded hole III (54) for threaded connection with the upper cover fixing screws (9) is opened in the middle of the circular column III (59). The bottom surface of the circular column II (58) protrudes from the bottom surface of the circular column III (59).

13. The motor brake device according to claim 6, characterized in that, a left side wall (611) and a right side wall (612) are connected on either side of the sloping plate (61) and the connecting part I (62); the other end of the sloping plate (61) is connected with a rear side wall (613), while the rear side wall (613) is connected with the left side wall (611) and the right side wall (612) respectively. The contact surface (622) between the connecting part I (62) and the spring (3) is a plane, and the clamping hole (621) is a through-hole.

14. The motor brake device according to claim 8, characterized in that, multi-layer annular steps are arranged in the upper part of the lower cover (5), the top surface of the lower cover (5) is a plane, and the through-holes V (52) are uniformly arranged at the edge of the top surface of the lower cover (5). A locating flange (832) protruding downward is arranged at the edge of the connecting part II (83). The locating flange (832) is connected with the rear side wall (812), and is clamped with the top of the lower cover (5).

15. A baby carriage, characterized in that, it comprises the motor brake device described in claim 1, along with a wheel, a frame, a motor (10), a gearbox and a brake handle. The motor (10) is fixed on the gearbox, the gearbox is fixed on the frame, the motor shaft head portion (102) is connected with the gearbox, the wheel is connected with the gearbox, and the steel wire rope (71) is connected and fixed to the brake handle.

16. The motor brake device according to claim 5, characterized in that, the cross section of the columnar part (421) is a rounded rectangle, and the inclined surface (423) is an inclined plane.

17. The motor brake device according to claim 6, characterized in that, the cross section of the columnar part (421) is a rounded rectangle, and the inclined surface (423) is an inclined plane.

18. The motor brake device according to claim 7, characterized in that, the cross section of the columnar part (421) is a rounded rectangle, and the inclined surface (423) is an inclined plane.

19. The motor brake device according to claim 8, characterized in that, the cross section of the columnar part (421) is a rounded rectangle, and the inclined surface (423) is an inclined plane.

20. The motor brake device according to claim 9, characterized in that, the cross section of the columnar part (421) is a rounded rectangle, and the inclined surface (423) is an inclined plane.
